(19) United States
(12) Patent Application Publication
(10) Pub. No.: US 2019/0132715 A1
(43) Pub. Date: May 2, 2019

(54) DETERMINING STORAGE FOR OBJECTS OF VARIOUS SIZES WHILE MAXIMIZING UTILIZATION AND ACCESS

(71) Applicant: BisiMobile Inc., Plainview, NY (US)

(72) Inventor: Daniel Marzouk, Plainview, NY (US)

(21) Appl. No.: 16/179,836

(22) Filed: Nov. 2, 2018

Related U.S. Application Data
(60) Provisional application No. 62/580,705, filed on Nov. 2, 2017.

(51) Int. Cl. H04W 4/35; G06Q 10/08; H04L 29/08; G06F 15/18

(52) U.S. Cl. CPC H04W 4/35; G06F 15/18; H04L 67/18; G06Q 10/0836

(57) ABSTRACT

Systems and methods disclosed herein relate to online systems and computer-implemented methods for matching requests for storage of objects of varied sizes to available storage spaces. In an example, a method receives, from a first user device, a storage listing including storage parameters. The storage parameters include dimensions of available storage space within a storage location. The method receives, from a second user device, a storage request including storage request parameters including dimensions of storage objects. The method determines a storage space configuration for the available storage space. The storage space configuration includes locations for the storage objects in an arrangement that maximizes use of the available storage space while leaving free space between the storage objects to allow access to each storage object. The method further determines whether all of the storage objects fit within the storage configuration.

### CROSS-REFERENCE TO RELATED APPLICATIONS

This application claims the benefit of U.S. Provisional Application No. 62/580,705, filed Nov. 2, 2017, which is incorporated herein by reference in its entirety.

### TECHNICAL FIELD

This disclosure relates generally to computer-implemented online storage space booking systems. In particular, this disclosure relates to online systems and computer-implemented methods for matching requests for storage of objects of varied sizes to available storage spaces and for determining an optimal arrangement of such items within a selected storage space.

### BACKGROUND

Solutions exist for electronically matching a service provider with an individual seeking a service. For example, solutions exist for matching short-term vacation rentals with individuals needing a vacation rental. Ride-sharing systems also exist for matching drivers with available seating in their vehicles with individuals needing a ride. But these services fail to address the unique challenges associated with renting varied amounts of storage space for varied size objects.

For example, such existing solutions cannot match a request to store varied size storage containers with available storage locations or portions thereof having sufficient space for storing the desired items. Such solutions cannot consider a set of constraints to ensure sufficient open space is available at a given storage location by automatically and intelligently predetermining whether the available open space can accommodate such containers in an optimal arrangement to not only maximize storage capacity, but to also ensure ease of access to all stored containers, including those already stored in such space, and ease of ingress to and egress from the storage location.

### SUMMARY

Systems and methods disclosed herein relate to online systems and computer-implemented methods for matching requests for storage of objects of varied sizes to available storage spaces. In an example, a method receives, from a first user device, a storage listing including storage parameters. The storage parameters include dimensions of available storage space within a storage location. The method receives, from a second user device, a storage request including storage request parameters including dimensions of storage objects. The method determines a storage space configuration for the available storage space. The storage space configuration includes locations for the storage objects in an arrangement that maximizes use of the available storage space while leaving free space between the storage objects to allow access to each storage object. The method further determines whether all of the storage objects fit within the storage configuration. Responsive to determining that storage objects fit within the storage configuration, the method presents the storage listing to the second user device.

### BRIEF DESCRIPTION OF THE FIGURES

Features, embodiments, and advantages of the present disclosure are better understood when the following Detailed Description is read with reference to the accompanying drawings.

FIG. 1 is a block diagram of a storage matching system, according to certain embodiments of the current disclosure.

FIG. 2 depicts an example method for servicing storage listing requests and storage queries, according to certain embodiments of the present disclosure.

FIG. 3 depicts a user interface of an example storage application for listing storage space, according to certain embodiments of the current disclosure.

FIG. 4 depicts a user interface of an example storage application for finding storage space, according to certain embodiments of the current disclosure.

FIG. 5 depicts shows a refined search based on a certain type of space desired by a tenant.

FIG. 6 is a flow chart showing the steps of an example storage space configuration process performed by a storage matching application, according to certain embodiments of the present disclosure.

FIG. 7 depicts a user interface of an example storage application for listing storage space, according to certain embodiments of the current disclosure.

FIG. 8 depicts an example system for implementing a storage application according to certain embodiments of the present disclosure.

### DETAILED DESCRIPTION

As discussed above, existing techniques cannot adequately facilitate the rental of variable amounts of storage space for storing various sized objects within a single storage location. For example, traditionally, a renter may use an electronic system to locate a six-foot by six-foot by ten-foot storage location, e.g., a self-storage locker or unit, for a certain amount per month. But such a system is constrained to fixed-size storage spaces and cannot match storage requests with any available storage space within a storage location by predetermining whether the available open spaces can accommodate such varied sizes of containers in an optimal arrangement to not only maximize storage capacity, but to also ensure ease of access to all stored containers and ease of ingress to and egress from the storage location. In contrast, the present solutions allow a single storage location, such as a storage locker, basement, garage, attic, shed, etc., to be concurrently rented to multiple parties so that each party can securely store its own arbitrary-sized objects within variable amounts of the available storage space, with each party having sufficient access to the storage space and its objects.

The disclosed solutions match storage containers, such as boxes, crates, drums, etc., and other objects, such as vehicles, furniture, and other items that are not placed within containers, with available storage locations based on criteria such as storage space size, location of and size of ingress and egress points, free space needed for ensuring accessibility to storage containers, and a maximum storage container or object size that can be accommodated. Disclosed systems therefore improve upon traditional self-storage models, which simply determine the availability storage locations having fixed-size storage spaces, i.e., available storage lockers.

In particular, disclosed solutions calculate optimal storage locations for multiple storage containers, while maximizing an available amount of storage space, ensuring egress to the storage location, ensuring access to stored items from multiple entities, ensuring separation of items from different sources, and expected storage time. By so doing, disclosed solutions facilitate the use of underutilized and available storefronts, garages and other storage locations as more convenient options for storage, while permitting easy access to and removal of storage containers and other objects from a storage location without disturbing any other items in the storage space.

The following non-limiting example is introduced for discussion purposes. A storage matching platform includes a storage matching server that communicates with a first user device and a second user device. Each user device executes an instance of a storage application. The first user device, operated by a potential landlord, transmits a set of storage parameters including a room size of ten by twelve feet and a location and size of a door for entering the room, the size of any other point of ingress to or egress from the storage location, such as dimensions of elevators, stairwells, etc. In turn, the storage matching server determines a candidate storage configuration that includes up to a total of twenty-eight storage containers of size one foot by one foot, in a configuration such that sixteen containers can be stored around the perimeter of the space with an additional twelve containers in the middle of the storage space, such that accessibility is maintained to all the containers. The candidate storage configuration accounts for egress and accessibility of individual storage containers.

Several different candidate storage configurations can be calculated based on different standard storage container sizes. In this manner, when receiving a request to store a one or more containers, the storage matching platform can quickly and easily determine which storage facilities can accommodate the containers. Additionally, if queries for additional or different size containers are received, then the storage matching server can recalculate the candidate storage configurations.

Continuing the example, a second user device receives a query from a prospective tenant seeking to store a number of containers. The query is for four containers of size one-foot by one-foot. In response, the storage matching server matches the storage container size with one of the candidate storage containers. The storage matching server predetermines the optimal placement of the candidate storage within the storage space, accounting for any other containers or objects already stored in the space and accounting for free space left for ingress, egress, and easy access to all containers and objects in the space. If the storage matching server determines that the landlord has sufficient available space to store the requested containers, it presents the second user device with an option to store at the landlord's premises. This process is of course performed with respect to all landlords participating in the service, so as to present the prospective tenant with a list of available storage options. The options may be filtered by location, cost, type of storage, e.g., heated, cooled, ground floor, top floor, and my many other metrics. Upon acceptance, the storage matching server confirms the storage reservation with both the first user device and the second user device. The storage matching server also presents the first user device instructions regarding the appropriate placement of the four storage containers to ensure maximum utilization of the space while also meeting the criteria regarding ingress to and egress from the storage location and access to all containers and other objects stored in the storage space.

In addition, some embodiments use barcoding to automatically inventory stored items. For example, a user device can upload a photo of items to be stored. In turn, the storage system can determine the type of objects depicted in the photo and automatically create an inventory. This may be done, for example using image recognition applications. For example, the storage system can maintain an inventory of items in each particular storage container. Based on automatically-generated object classifications, the storage system can quickly service user queries for specific items, for example “Winter Boots” or “Summer Clothes” without needing to open each box, because the tenant knows in which box a particular item is stored. All of this inventory and classification can be associated with a bar code that is securely affixed to each storage container or other object. Additionally, the storage system can be integrated with external systems to facilitate the certification of the space via a third party, automatically create shipping manifests to ship items in storage, or purchase additional insurance through the storage application.

As used herein, “landlord” refers to a party owning or controlling a storage location and “tenant” refers to a party having objects to be stored in a storage location. It should be appreciated that models for sharing storage space other than landlord-tenant relationships between the parties may be used and that storage space does not necessarily need to be rented in a traditional sense.

As used herein, “storage container” refers to a container for which temporary or permanent storage is sought. Containers include boxes, crates, drums, and any other means for holding items.

As used herein, “storage object” or “storage item” refers broadly to storage containers and any other items or objects to be stored, such as boats, sporting equipment, cars, trucks, furniture, etc.

As used herein “storage configuration” refers to a configuration of one or more storage objects within a storage space such that a set of constraints, or parameters, are met.

As used herein “storage location” refers to a physical location, such as a garage, basement, shed, attic, room, or locker, that contains space in which storage object can be stored.

As used herein “storage space” refers to the space within a storage location. Different storage spaces within a storage location can be used by different tenants.

As used herein “standard size” refers to a one of a predetermined set of container sizes. Examples of sizes include one foot cubed and one foot by two feet by one foot. Storage containers and other storage objects may be of standard size or non-standard size.

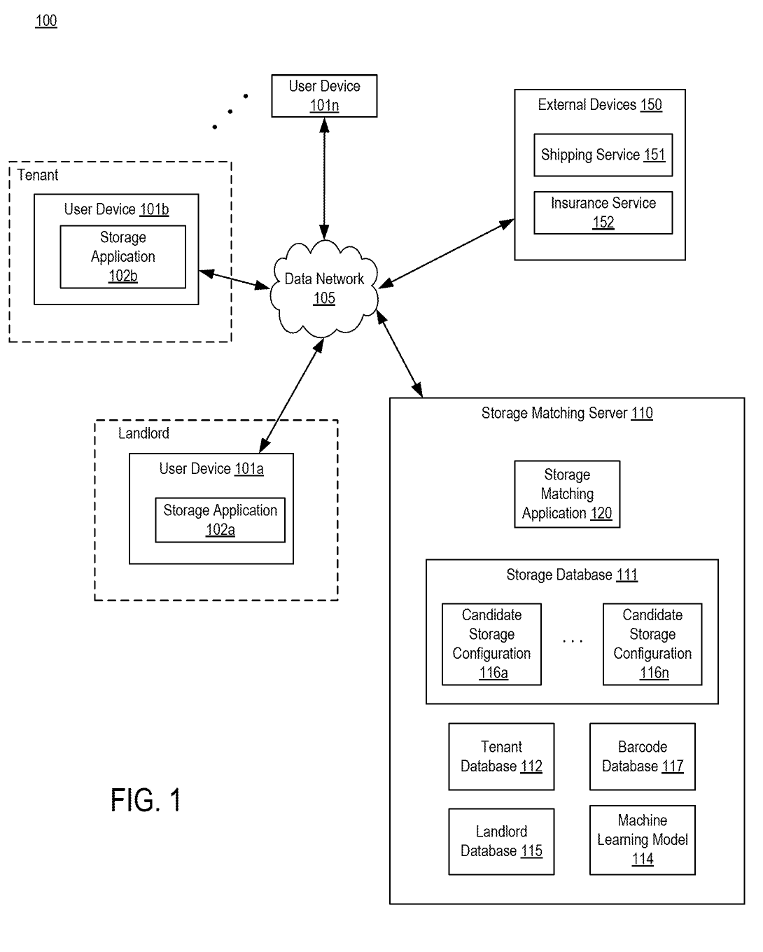

Turning now to the Figures, FIG. 1 is a block diagram of a storage matching system, according to certain embodiments of the current disclosure. FIG. 1 depicts storage matching system 100, which includes one or more of user devices 101a-n, storage matching server 110, external devices 150, and a data network 105, which is any suitable network such as the internet, local area network (LAN), wide area network (WAN), wired network, or wireless network.

Storage matching server 110 executes storage matching application 120, which can receive storage listings from user devices operated by landlords (e.g., 101a) and storage requests from user devices operated by tenants (e.g., 101b). Storage matching application 120 is configured to identify available storage space based on parameters provided by each landlord and each a prospective tenant and to present the prospective tenant with available storage options. Storage matching application 120 may also be configured to communicate with external devices 150 to integrate third party service offerings, such as shipping and storage insurance.

In an example, storage application 102a, executing on user device 101a, is used by a potential landlord to list available space within a storage location. Storage application 102b executing on user device 101b is used by a potential tenant to requests for available storage space meeting the tenant's storage needs. In some embodiments, different user devices 101a-b use can use different applications, for example a specialized application for landlords and a specialized application for tenants.

Any number of user devices 101a-n operated by any number of landlords or any number of tenants can be used within the system for listing or requesting storage space. All user devices 101a-n connect, via data network 105, to storage matching server 110, which executed routines for identifying available storage spaces meeting the tenant's requests.

Storage matching application 120 maintains one or more data structures to facilitate matching of storage queries with available space and for maximizing the utilization of each storage space. In an example, storage matching application 120 includes storage database 111, tenant database 112, machine learning model 114, landlord database 115, and barcode database 117. Each database can use different implementations such as a data structure, a table, or an Extensible Markup Language (XML) property list. Is should be appreciated that a single database or any other number of databases could contain some or all of the foregoing databases or the data included in such databases. The databases 111, 112, 115, and 117 are shown and discussed as individual databases for ease of reference only.

Landlord database 115 includes an entry for each landlord that has provided current or previous storage listing. Examples of data values stored in landlord database 115 include landlord name, address, zip code, room dimensions, door location and dimensions, locations, dimensions, and types of other points of ingress and egress, availability of climate control, certification records, landlord ratings, and any other data pertinent to rental of storage space, as well as an inventory of items currently stored in the storage space.

Storage matching application 120 can determine match between storage listings from landlords and storage requests from tenants. This matching can occur at one or more points during operation of the system. For example, in some cases, storage matching application 120 can determine or update available storage in response to storage listing requests from a landlord or storage query requests from a tenant.

In other cases, for example to improve system performance, storage matching application 120 can predetermine a candidate storage configurations 116a-n. Candidate storage configurations 116a-n can each be based on a standard size storage container or sizes of items expected to be stored such as sporting equipment. Each candidate storage configuration 116a-n can include possible storage configurations and an identifier of any particular storage containers stored in a particular storage area. In this manner, storage matching application 120 can more quickly service a request from a tenant at runtime.

Tenant database 112 includes information about potential or actual tenants using storage system. Each entry in tenant database 112 can include parameters such as tenant name, address, an inventory of the number, types and dimensions of items stored or to be stored, item identifiers, and present location of items stored or to be stored.

In an embodiment, storage matching server 110 can use machine learning to determine objects depicted in images uploaded by a user device 101a-n. For example, a tenant or a landlord can operate a user device 101a-n to upload an image of items to be stored in a storage container. In turn, storage matching server 110 provides the image to machine learning model 114, which identifies any objects present in the image. Identified objects can be automatically stored in an inventory recorded in tenant database 112 or landlord database 115.

Machine learning model 114 can use different types of machine learning including supervised learning, unsupervised learning, or reinforcement learning. Machine learning model can be trained using standard training methods such as providing known images tagged with object names or types to machine learning model 114 and optimizing a loss function. Several forms of image recognition routines many be used within the machine learning model, such as image classifiers, and regression algorithms. Additionally, machine learning model 114 can be located on a remote server connected via data network 105.

From an uploaded photo, machine learning model 114 can determine any items to be stored, thereby removing the need for manual entry of items and item types. For example, a tenant or a landlord can operate a smart phone or other camera device to take a picture of items as placed within a storage container. The smart phone may serve as the user device 101a, itself executing the storage application 102a, or the image may be transferred image to a separate user device, e.g., user device 101a or the storage matching server 110. For example, storage application 102a may interact with the machine learning model 114 executed on the storage matching server, or may execute a local instance of a machine learning model 114, to automatically identify items within the image and generate descriptions of the items. In another example, the user device 102a uploads the image to the storage matching server 110.

For example, the machine learning model 114 can identify a fork, knife, shelf, broom, mop, a necklace or any other objects placed within a storage container or to be stored without a storage container. The resulting information may be sent to the user device 101a, where the storage application 102a displays the determined items in an inventory view on a user interface. Through the storage application 102a, a user can then search for items located within the storage space, for example to determine which items are in which box and exactly where the relevant boxes are positioned within the storage space. A user can use the storage application 102a to request access to particular storage containers and find the required storage items without needing to disturb any other item located in the storage space.

Information identifying items contained within storage containers and the locations of the containers or other storage objects within a storage space may be encoded in or associated with a bar code. The barcode may be affixed to a storage container such that the landlord or tenant can scan the bar code to determine which items are located in the container. In another embodiment, bar codes can be generated (e.g., the storage application 102a operated by the tenant) for each item to be placed within a storage container and can be affixed to the individual item. In this manner, images of the items with their associated bar codes may be uploaded to the storage matching server 110, which can use a bar coding application to scan the bar codes shown in the received images to generate records of the items. In some embodiments, storage matching server 110 may compare the determined bar code with entries in barcode database 117, which can include a database of standard barcodes, to determine an item's identity. When an item's identity is confirmed, the storage matching server 110 includes the item in an inventory of items that are stored or to be stored in the storage space.

User devices 110a-n and storage matching server 110 can communicate with external devices 150 in order to automatically facilitate additional services such as shipping service 151 or insurance service 152. For example, a user device 101a may send a request to storage matching server 110 indicating that a user wishes to ship items in storage to the user or to another party. The user may also desire to ship items to be stored to the landlord. In turn, storage matching server 110 contacts one or more shipping services 151 to automatically arrange suitable pickup and delivery services for the requested items. In another example, a storage application 102a executed on a user device 101a requests property insurance for items stored or to be stored in a storage space. In turn, storage matching server 110 may facilitate insurance quotes from various third party insurance services 152 based on parameters provided by the user. The storage matching server 110 may present the quotes to the storage application 102a. In response to the user indicating acceptance of a quote, storage matching server 110 can facilitate the user's enrollment into an insurance plan. In other embodiments, the user device 101a may interact directly with a shipping service 151, insurance service 152, or any other relevant third party service to improve the storage process.

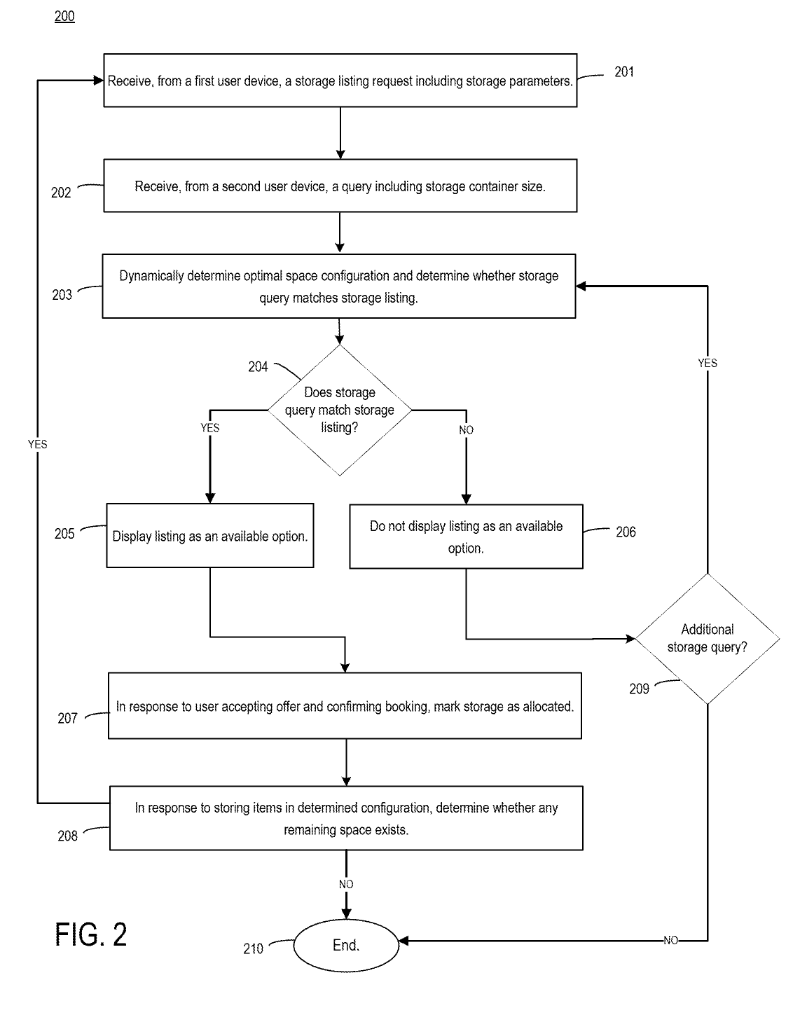

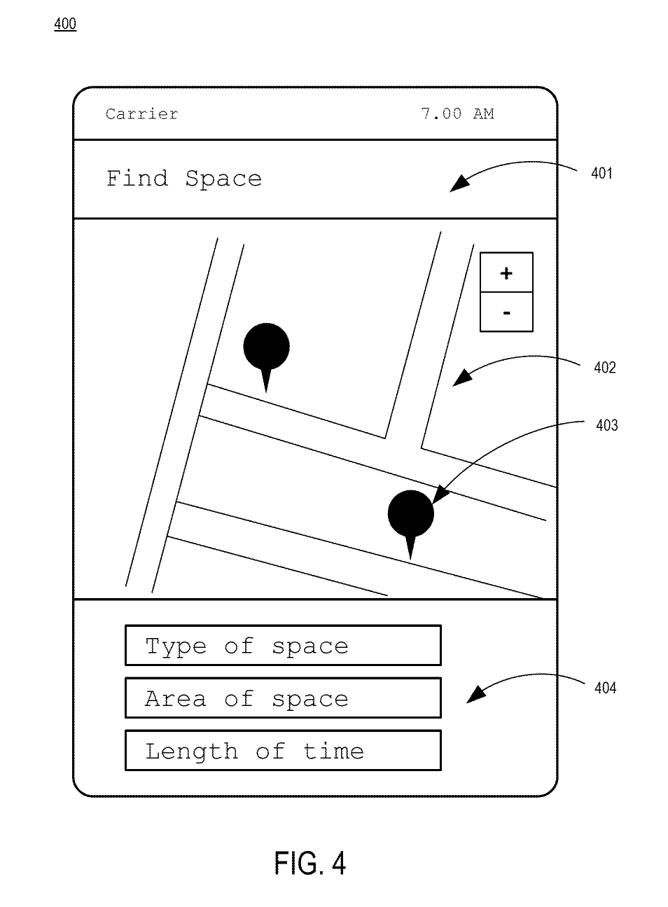

FIG. 2 depicts an example method 200 for servicing storage listing requests and storage queries, according to certain embodiments of the present disclosure. For example purposes, FIG. 2 is discussed in conjunction with examples of user interfaces depicted FIGS. 4-5 and 7. But other user interfaces are possible.

At block 201, method 200 involves receiving, from a first user device, a storage listing request including storage parameters. User device 101a, operated by a potential landlord, receives input specify the desire for a new storage listing and the storage parameters that define the storage space, which can include any data relevant to a storage space offered by a landlord. The user device 101a then transmits the parameters to storage matching server 110.

Examples of storage parameters include room size, a location and the dimensions of all (or at least the smallest) ingress and egress points, such as stairs, doors, and elevators, or other obstacles that must be traversed to reach the storage location, a maximum storage container size, acceptable item type, and a maximum weight that can be carried by the landlord. Size can be specified by a triple of width, depth, and height. Obstacles taken into consideration by the storage matching platform include windows, heaters, and air conditioners. Other parameters may include the size of any space the landlord desires to remain open between storage objects, e.g., to create pathways or other means of easy access to storage objects.

In some cases, user device 101a receives some or all of the room parameters directly from user input via a user interface of storage application 102a. In other embodiments, some of the storage parameters may be set as defaults or dynamically determined by the storage application 102a or the storage matching server 110.

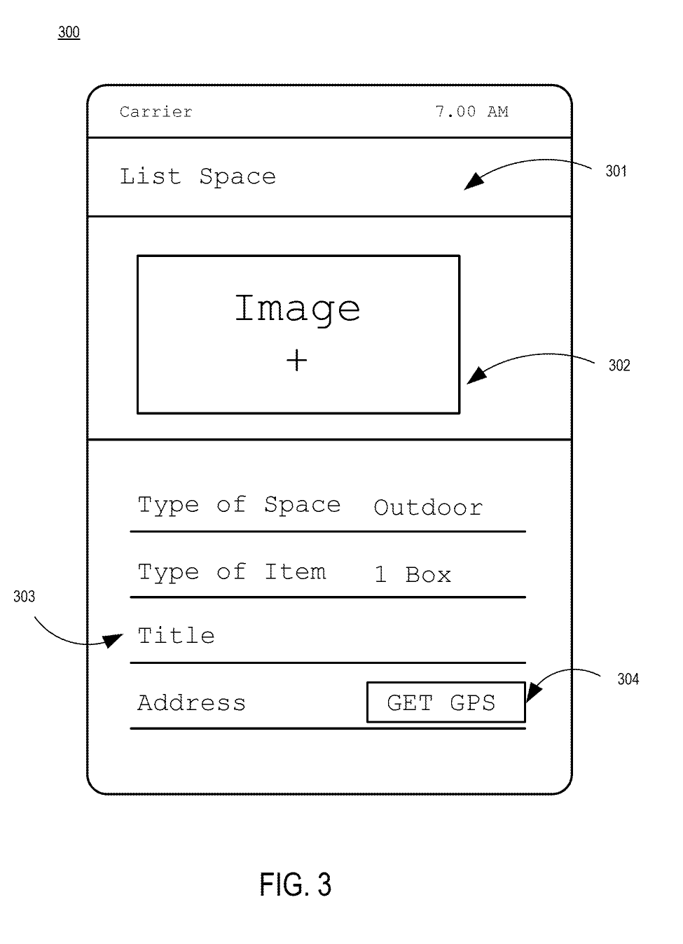

FIG. 3 depicts an illustrative user interface of an example storage application for listing storage space (e.g., block 201 in FIG. 2), according to certain embodiments of the current disclosure. FIG. 3 depicts user interface 300, which includes title bar 301, image uploader tool 302 for interfacing with an imaging device (e.g., a camera) to select and add images of the storage location, input fields for specifying parameters 303, and GPS button 304 for using GPS or other location based services to automatically determine the location of the user device 101a. User device 101a receives commands and displays output via user interface 300.

Parameters 303 can include type of space, item type, title of the space, and address. Examples of the type of space are outdoor, indoor, closet, garage, basement, climate controlled, etc. Multiple types of space can be listed. For example, a landlord may have both a basement and a garage to rent. Examples of item types that can be stored within the storage space include one large box, two large boxes, one small box, or a couch. The landlord can enter his or her address along with a title for the space which is the way the listing will be seen by tenants when searching for space (e.g., “space in garage.”). In an embodiment, the landlord may specify the Global Positioning System (GPS) coordinates (e.g., latitude and longitude) or enter the coordinates automatically via location detection on a mobile device. In other embodiments, the landlord may specify items that he or she may not accept, e.g., a chair, dangerous chemicals, etc.

In other cases, storage application 102a receives an image or photo of the space and uploads the image for processing. For example, storage application 102a can receive images via image uploader tool 302. In this case, the storage matching server 110 provides the image to machine learning model 114 for object recognition and to determine the dimensions, egress, and obstacles in the storage area. Storage matching server 110 then uses the determined room parameters for further calculations.

In an embodiment, storage matching server 110 can receive an uploaded photo of a street view of the location and cross-reference the photo with an online database. Machine learning model 114 can determine a verification score that indicates a likelihood that a description provided by landlord is correct.

In some embodiments, the storage application 102a requires that the landlord sign register an account, e.g., with a provider or operator of the storage matching platform 100, and add profile information such as first name, last name, email, password, or street address. The sign up process may require the landlord to agree to legal terms by checking a box, inputting a signature, etc., or require submission of a photograph of the individual opening the account. In some cases, the landlord may be required to agree to certain terms and conditions applicable to the storage listing and any storage transaction. For example, such as an agreement may include provisions regarding resolution of disputes regarding non-payment by the landlord to the service provider or by the tenant to the landlord. The landlord may also be required to warrant the safety and security of items to be stored in its storage space.

In other embodiments, the landlord may also desire to list its storage space as a premier space, which may be promoted by the service provider as a preferred storage listing. A storage listing may be designated as a premier space based on a fee payed by the landlord to the service provider, via a subscription model in which the landlord enrolls, or by another other suitable arrangement between the landlord and service provider. A landlord may upgrade an account to the premier service at a later time.

In yet further embodiments, a tenant is also required to step up an account and agree to certain terms and conditions. For example, a tenant may warrant that they will not store items which are on a prohibited list or are dangerous or unlawful, and warrant that the tenant has the right to store the items. The terms may provide how to resolve a dispute regarding non-payment, or loss or damage to the storage items while in the landlord's possession, for example.

Returning to FIG. 2, at block 202, method 200 involves receiving, via user device 101b, a storage query including a storage container size. The request includes parameters specifying the characteristics of the storage objects and other criteria such as the type and geographic location of the storage location. In particular, user device 101b receives one or more inputs specifying one or more criteria such as storage container size, item types, desired geographic location of storage location (e.g., within a specified radius of the tenant's location), expected rental duration, and specific characteristics of the storage space (e.g., climate controlled).

FIG. 4 depicts a user interface of an example storage application 102b for entering a storage query (e.g., block 202 in FIG. 2.), according to certain embodiments of the current disclosure. FIG. 4 depicts user interface 400, which includes title bar 401, map 402, pin 403, and parameters 404. In an example, a user enters criteria in parameters 404 such as type of space, area of space, and length of time of storage. User device 101b sends the parameters to storage matching server 110, which determines one or more desirable storage locations. The user device receives the storage locations and displays them on a map, as shown by pin 403. Additionally, the user interface may have an option to enter a date on which the space is needed (move-in date), type of items to be stored, or other parameters.

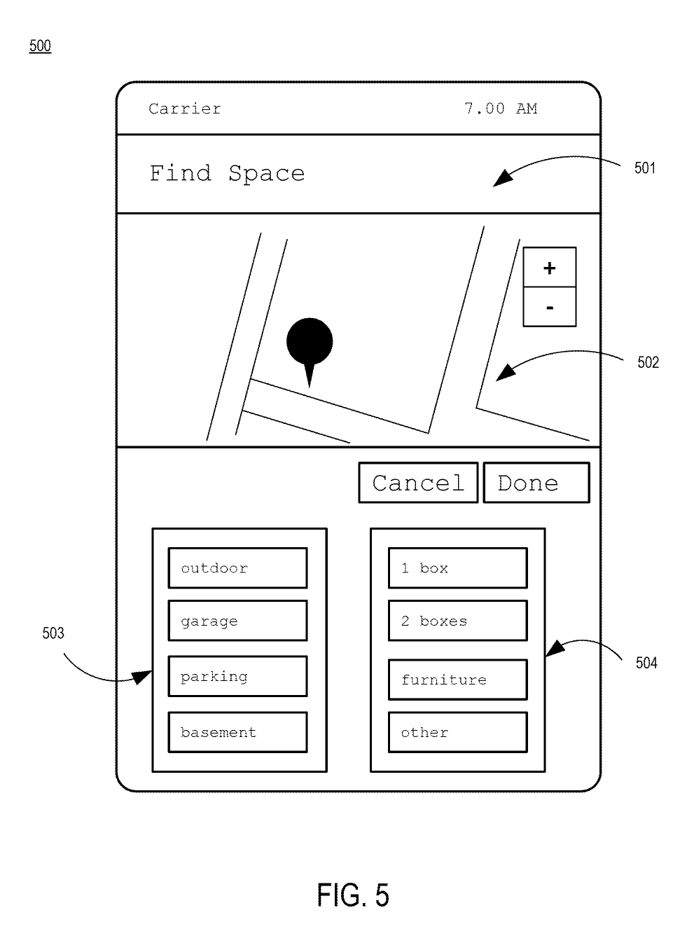

FIG. 5 shows a refined search based on a certain type of space desired by a tenant. Alternatively or in addition to allowing the tenant to specify the number of boxes or furniture to be stored, the user may choose another type of storage (garage, basement, closet, etc.), and the area required (e.g., square feet). For example, storage may be available outdoors, in a garage, or a basement.

FIG. 5 depicts user interface 500, which includes title bar 501, map 502, first parameter set 503, and second parameter set 504. In an example, a user can select a parameter from first parameter set 503 and a parameter from second parameter set 504, which are provided as part of the query or as a filter, via a user device, to storage matching server 110.

After the prospective tenant completes and submits the storage request, the user device 101b relays the request to storage matching server 110.

Returning to FIG. 2, at block 203, the storage matching application 120 dynamically determines, optimal space configuration and determines whether storage query matches storage listing. To match a storage query with a storage listing, storage matching application 120 considers the storage parameters received from the landlord or the storage container from the tenant. Further, the storage matching that occurs at block 203 can execute at one or more places during method 200.

Storage matching application 120 optimizes different constraints such as an optimal storage locations for a particular size storage container, while maximizing an available amount of storage space, ensuring egress to the storage location, ensuring access to stored items from multiple entities, ensuring separation of items from different sources, and expected storage time.

In an embodiment, the storage matching application 120 determines an ingress or egress route or a margin. For example, in a square room, the ingress or egress route can be a margin located between an outer set of storage containers against the walls and an inner set of storage containers that follow the contours of the storage area. The margin can be both sufficiently wide to remove a box from the square buffer and sufficiently wide to provide egress for person.

In a further embodiment, storage matching application 120 starts with the largest storage container and places the storage container into a furthest corner from the door. In other cases, storage matching application 120 can reconfigure the margins (and request that a landlord move storage locations) based on additional information received such as a request for additional storage or the removal of one or more containers.

In some embodiments, storage matching application 120 determines a set of candidate storage configurations based on the storage parameters. Each candidate storage configuration represents a possible configuration of storage containers various sizes with corresponding locations for each container. For example, for a given storage space, a first storage configuration could accommodate five two-feet by two-feet by two-feet boxes and a second storage configuration could accommodate twelve one-foot by one-foot by one-foot boxes. In some embodiments these candidate storage configurations are determined as part of block 203 and may be presented to the landlord for selection of a preferred configuration.

In other embodiments, the candidate storage configurations may be determined prior to receipt of a storage query, i.e., prior to block 202, and presented to the landlord to assist the landlord with determining how to best utilize the storage space and what prices to set for portions of the space or different sizes of storage objects.

In yet another embodiment, storage matching application 120 uses machine learning model 114 to determine a space configuration of a storage location. Machine learning model 114 can be trained using standard methods. In an example, machine learning model receives a training set including training pairs. Each training pair includes an image depicting a storage space (e.g., taken with a camera) and a known space configuration. Training includes performing a set of steps for each training pair. The set of steps include receiving a predicted storage configuration from the machine learning model, calculating a loss function based on a difference between the predicted storage configuration and the known space configuration, and adjusting a parameter of the machine learning model such that the loss function is minimized.

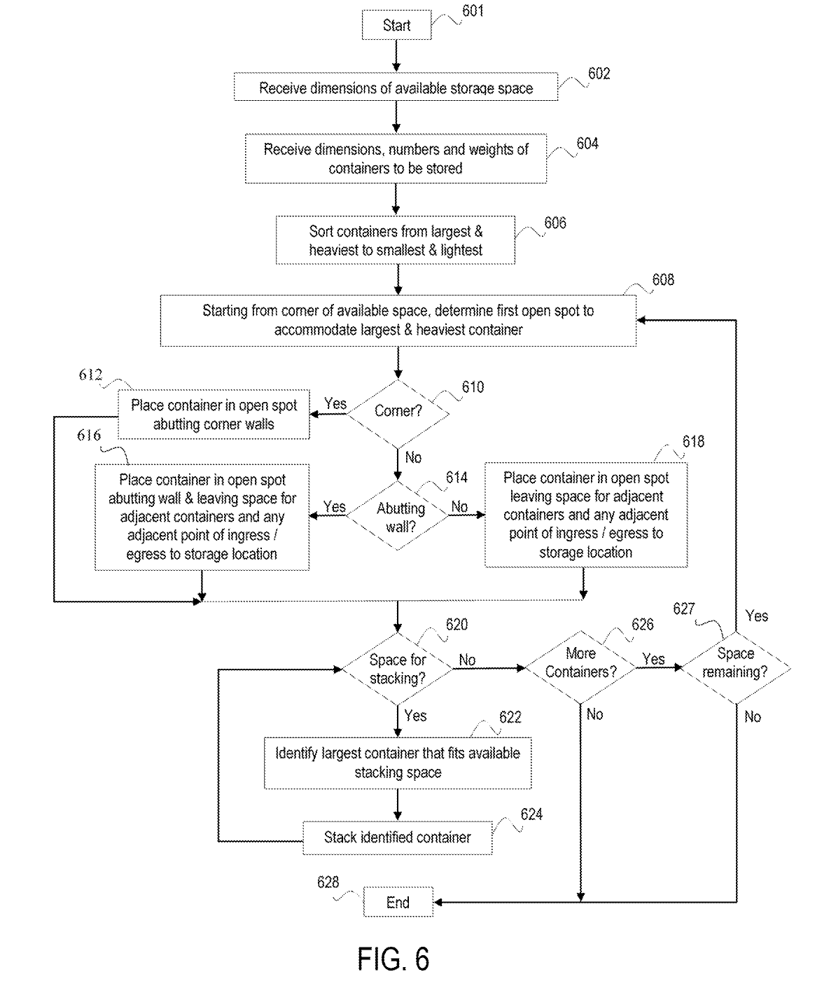

Storage matching application 120 can use different methods determine a possible storage configuration. An example includes representing room size, margins for egress, and any other constraints and providing the representation to a linear programming model to provide one or more possible solutions. An example method is illustrated by FIG. 6, but other methods can be used.

FIG. 6 is a flow chart showing the steps of an example storage space configuration process performed by a storage matching application, which may be executed in some embodiments for determining whether a storage query matches a storage listing (e.g., block 203 in FIG. 2). This process can also be performed by the storage application 102a running on the landlord's user device 101a in some embodiments. For the sake of simplicity and clarity of explanation, the example described relative to FIG. 6 assumes a simple cubic shaped storage space having a length, width and height. The example also assumes that all items to be stored are placed within storage containers having either standard sizes (e.g., small medium, and large) or non-standard sizes. Each storage container has a length, width, height, and weight.

The process begins at starting block 601 and proceeds to block 602 where dimensions of the available storage space are received. The dimensions may be the dimensions of the entire storage location, e.g., room, garage, storage locker, etc., or the dimension of any unused portion of the storage location having open space in which new storage containers may be place. Next, at block 604, the dimensions, numbers and weights of the tenant's storage containers to be stored are received. At block 606, the storage containers are sorted from largest and heaviest to smallest and lightest. The goal in some embodiments is to place the largest and heaviest containers on the floor and to stack smaller and lighter containers on top of those, to the extent possible.

In block 606, for the sake of comparison among standard size containers and non-standard size containers, the dimensions of any non-standard size containers may in some embodiments by rounded up to the nearest corresponding standard size dimension or the next factor or multiple thereof. For example, if the standard large container has a length of 36 inches, a width of 24 inches, and a height of 24 inches and non-standard size container has a length of 30 inches, a width of 22 inches, and a height of 24 inches, the length of the standard container will be rounded up to 36 inches and the width will be rounded up to 24 inches. This example assumes that the non-standard size container is closest in overall size to the standard large container and not the standard medium or standard small container, but the same principles would be applied if the non-standard size container is to be standardized to the dimension of either of those standard size containers. In other embodiments, all storage containers may be rounded up in all dimensions to a closest standardized dimension, e.g., the closest six inches or any other unit of measurement set as a system default or manually set by the landlord. Those skilled in the art will also appreciate that the rounding process is optional. In other embodiments non-standard sized containers can be compared as they are to the standard size containers for the sake of sorting from largest and heaviest containers to smallest and lightest containers. Odd-sized or shaped storage containers may be treated separately due to potential difficulty in fitting and stacking them with other containers.

When the sorting is complete, the method proceed to block 608, where the first (or next) open spot within the available storage space that can accommodate the first (or next) largest and heaviest storage container is determined. In making this determination, the method starts at the furthest corner of the storage space, i.e. furthest from the point of ingress or egress and progresses from there along either wall that forms the corner and then outward from there to identify the first (or next) open spot. At block 610, a determination is made as to whether the open spot is in a corner. If so, the container is places in the open spot abutting the corner walls at block 612.

If the open spot is not in a corner, the method moves to block 614 for a determination as to whether the open spot otherwise abuts a wall. If so, the container is placed in the open spot abutting the wall and leaving space on its other three sides to separate the container from any adjacent containers between and any adjacent point(s) of ingress or egress. The space that is left open may allow for more easy access to other containers that may be placed adjacent to the container or to any adjacent point(s) of ingress or egress. This open space may be a default size, e.g. 18 inches, or may be manually set by the landlord using the storage application 102a, which may transmit the setting to the storage matching server 110. The amount of open space may be different when accounting for adjacent containers versus points of ingress or egress. For example, more free space may be need to accommodate the opening of doors than is needed for accommodating access to adjacent containers. If the open spot does not abut at least one wall, the method moves from block 614 to block 618, for placement of the container in the open spot while leaving free space on all four sides of the container to separate it from any adjacent containers and any adjacent point(s) of ingress or egress.

After placement of the container in any of blocks 612, 616, or 618, the method proceeds to block 620, where a determination is made as to whether space remains available for stacking. For example, the remaining space above the storage container may be calculated and compared at block 622 to the dimensions of the next largest container to determine if it will fit within that available space. If not, the method may consider each of the remaining items in decreasing size to determine if any of them will fit within the remaining space above the placed container. This block could also involve a determination of whether any container that will fit the available space is too heavy to be stacked. For example, the weight of each container available for stacking according to its size may be compared against a default or manually selected weight limit. Those exceeding the weight limit will not be stacked, while those not exceeding the weight limit may be stacked.

If space is available for stacking, the method advances to block 624 where the container identified for stacking is stacked on top of the prior container. From block 624, the method returns to block 620 for a determination as to whether additional space remain for stacking more containers. If so, blocks 622 and 624 are repeated as previously explained. When it is determined at block 620 that no additional space is available for stacking, the method moves to block 626 where it is determined whether any other containers require placement in the storage space. If so, it is determined at block 627 whether an free space remains in the storage space. If more space is available, the method returns to block 608 for identification of the next open storage spot that can accommodate the next largest and heaviest storage container. The method then advances to block 610 and is repeated from that point as described above until it is determined at block 626 that no containers remain for placement. When it is determined at block 626 that no containers remain or at block 627 that no free storage space remains, the method ends at block 628.

Those skilled in the art will appreciate that the above describe storage configuration process is but one example and is provided only by way of explanation of the concept. The above process may involve additional or fewer blocks, or some of the blocks may be rearranged, in other embodiments. Those skilled in the art will also appreciate that storage configuration processes may involve many additional blocks and may become more complex in cases where the storage space is not cubic and when the tenant desires to store odd sized containers or items that are not within containers. Machine learning model 114 may be employed to determine the best available room configuration that maximizes space while ensuring ease of access to the storage containers and ease of access to the storage location or storage space, as described herein.

Returning to FIG. 2, at block 204, method 200 involves determining whether the storage query matches a storage listing. Storage matching application 120 determines whether there is a match a correspondence between the size of the available space and the size of the container to be stored. User device 101b transmits the storage container size and any additional desired attributes such as location or price to storage matching application 120. Storage matching application 120 returns all available landlords from landlord database 115 that can accommodate the particular box size.

In some cases, the storage matching application 120 uses container sizes that are based on a standard size. For example, if a non-standard item is to be stored, then the storage matching server 110 can round each dimension of the size of the non-standard item to the nearest standard size.

In some cases, storage matching application 120 apply a filter received from user device 101b. The filter can include specified values or ranges for a distance from a location, a price, an availability of climate control, presence or number of any stairs leading up to or within the storage location, or other constraints.

If an item's optimum or acceptable configuration is possible and all other parameters align (e.g., desired storage duration, geographic location, price, and other characteristics match the offered storage duration, geographic location, price, other characteristics), the storage listing may be presented to the storage application 102b as an available listing (e.g. along with other available storage listings). If not, the storage listing is determined not to match the storage request and is not presented to the storage application 102b.

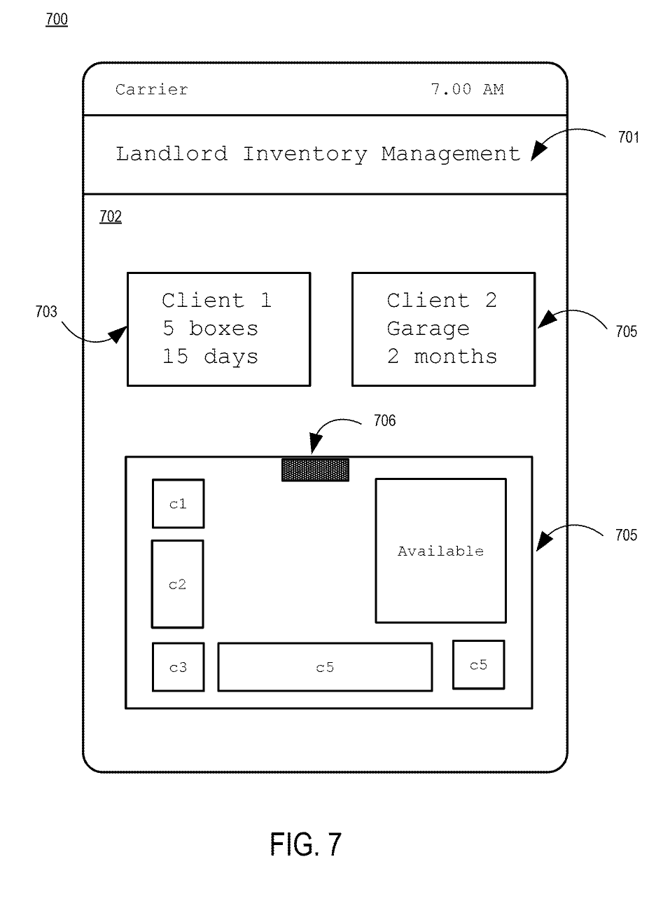

FIG. 7 depicts a user interface of an example storage application for managing inventory of stored objects and available storage space, according to certain embodiments of the current disclosure. FIG. 7 depicts user interface 700, which includes title 701 and storage view 702. Storage view 702 includes indicators 703 and 707, map 705, which in this example includes an obstruction 706.

Storage view 702 allows the landlord to see where objects are current stored in their storage space, whose items are there, and how long the items will be stored. In addition, the landlord can view a size and a configuration of the remaining open space.

In some cases, a pie chart can be shown (not depicted). A pie chart can shows the proportion of occupied, booked, and available space for a particular location. Additionally, the storage application shows the location of the different types of space. Different stored items, or boxes, maybe labeled with identifiers, e.g., “c1,” for client 1 and “c2,” for client 2.

With continuing reference to FIG. 2, if it is determined at block 204 that the storage query matches the storage listing, method 200 continues at block 205 where the storage matching application 120 provides the storage listing as an available option to the storage application 102b executing on the prospective tenant's user device 101b. If the storage query does not match, then method 200 continues at 206 and the storage matching application 120 does not provide the storage listing as an available option to the storage application 102b executing on the prospective tenant's user device 101b.

In an embodiment, the storage matching application 120 calculates locations of storage containers such that no storage containers from a first entity or tenant are stacked above or below storage containers from a second entity or tenant. This requirement can be added as a constraint. In this manner, in order to remove a particular tenant's storage container, the second tenant's item can be removed without distributing the first tenant's containers.

If the storage matching application 120 provides the storage listing as an available option at block 205, method 200 proceeds from there to block 207, where, in response to the tenant user accepting the storage offer and confirming a booking, the storage space is marked as allocated.

From block 207, method 200 moves to block 208, where, in response to storing items in the determined configuration, a determination is made as to whether any remaining space exists and whether the landlord wants to post another listing for that remaining space. For example, reflecting the change in allocated storage, the storage matching application 120 removes that allocated space from the available space remaining in the storage location. More specifically, storage matching application 120 may recalculate an updated set of standard storage configurations in a similar fashion as block 202. If the landlord wants to offer the remaining space to prospective tenants, the method returns to block 201 and is repeated from there as described above.

At any time it is determined at block 206 that the storage request does not match the landlord's storage listing, the method moves to block 209, where it is determined whether any additional storage queries are received that could potentially match the landlord's listing. If so, method 200 returns to block 203 and is repeated from that point as described above.

Whenever it is determined at block 208 that no storage space remains in the storage location or it is determined at block 209 that no additional storage queries have been received, method 200 terminates at block 210.

User device 101b and storage matching application 120 can perform an inventory of items in the storage container via various methods. For example, in an embodiment, user device receives, from a tenant, the items to be stored. In another embodiment, user device uploads photo of items, and storage system uses machine learning model 114 to automatically determine items in the photo, and inventories those items. In another embodiment, a user device receives barcodes of items, including standard bar codes that are present on product packaging.

Storage matching system 100 can also use barcodes for containers of stored items. For example, storage matching application 120 can assign barcodes to each stored container that identify tenant, landlord, or both. Containers can also be sealed with a zip tie to prevent tampering. In some cases, standard boxes can be used to facilitate stacking and more efficient use of space. Standard barcodes can be stored in barcode database 117. In conjunction with candidate storage configuration 116a-n, barcodes on storage containers can also identify, for a landlord, where items are located and for the tenant to identify items in boxes.

In some embodiments, the storage application provides a rating system. The rating system permits both tenants and landlords to provide and receive rating feedback. A space for rent may be tagged with the landlord's rating, for example. Users can be removed for poor ratings. The dual rating allows for both tenant and landlord to understand a little more about the person who may be their tenant or landlord. After the booking is complete the landlord and tenant have an opportunity to rate each other. The rating is shown in the aggregate scoring for tenants and landlords to review. The landlord or tenant may see any reviews via the storage application. For example, a tenant can identify that a landlord has a low rating, and decline to use that landlord for storage.

External System Integration

In some embodiments, the storage application can facilitate a request to a third party provider to have items picked up and delivered from or to the landlord or tenant. The property owner can request payment it will be sent to the proprietor. In this case, storage matching application 102 communicates a request to an external shipping service 152. In turn, shipping service 152 can send a shipping status back to storage matching application 102, which communicates the status back to a user device 101a-b.

In other embodiments, storage matching application 120 can detect that a threshold amount of time has elapsed without any shipping containers being added or removed by a tenant or no interaction between the storage system and the tenant. Responsive to this detection, storage matching application 120 can send a notification to the tenant's user device asking whether the tenant would like some or all of the items stored at a landlord or multiple landlords to be listed on an auction site. User device 101a-b can solicit an appropriate price from the tenant, or can determine an appropriate price at fair market value from an online database. To do so, storage matching application 120 contacts an external device to facilitate the listing and sale of the items. Following the sale, the storage container previously used can be used by another tenant or a landlord.

In yet additional embodiments, storage matching application 120 can interact with external services that facilitate car service such as oil changes or car washes. User devices 101a-b, in conjunction with storage matching application 120, can be used to make reservations with these external services. Storage matching application 120 can communicate requests and confirm reservations with the external service and can receive updates from the external services.

In certain embodiments, the storage application can assist a landlord or a tenant in easily creating an inventory of items, finding items, and maximizing space and storage utilization. The inventory management system can operate in conjunction with a barcode scanning system. The barcode system prints a unique barcode for each item that is brought into storage. The barcode can be linked to the tenant's account. Each time an item is brought into or removed from the storage space, a new booking may be created, and the pricing model may be adjusted and restarted. Accordingly, the storage application may provide the tenant the ability to pay for only the storage that he or she is using. For example, a tenant need not pay for more storage than necessary, as is the case when renting storage space within a traditional, fixed-size facility. The storage application allows for easily finding the exact item a tenant needs without opening each box and moving all the items. In addition, in some embodiments, the storage application can quickly facilitate matching the tenant with third-party providers of necessary goods and services, such as boxes and movers, which can make the storage process faster, simpler, and more convenient.

In other embodiments, the storage matching platform provides a messaging system via the storage application. Prospective and actual landlords and tenants may message each other through the application. Messaging is kept secure and allows for personal information such as email address and phone number to be kept private.

In yet other embodiments, the storage application facilitates certification of a landlord's space by a third party. Such a certification process allows for a third party vendor to provide photos and descriptions of the location to assist in verifying the information provided by the landlord to the storage application. The certification process brings a new level of security to the tenant. Certification can provide the uploaded photos and a professional loss control inspector's opinion of the risk to be provided. In some embodiments, based on the certification process, a system administrator may remove a listing that may no longer qualify to be listed. Users may search only for certified listings in addition to other search criteria.

In some embodiments, the storage application may facilitate on demand insurance. Such insurance provides the ability for both landlords and tenants to purchase insurance for the items, and landlords to purchase insurance for their space and other tenant's items. In an embodiment, a threshold insurance amount of $5,000 is provided, which the tenant may adjust as necessary. The tenant may also opt out of insurance. The landlord may be offered insurance also upon entering the booking process.

Embodiments described herein provide an option that is more flexible and convenient than traditional self-storage by providing an easy way to track items, identify usable space, and certify a storage space. Unlike self-storage traditional self-storage models, the self-storage matching platform disclosed herein allows individual items to easily be removed and added at any time and pay only for the space being used, i.e., the rental price can be adjusted based on the amount of rented space. Hence, renters do not overpay for unused space and underutilize the space that the renter thought was required. Landlords can more fully utilize their space. A landlord can visualize, in real time, items stored on his or her premises, how long items have been stored, and how much space is available for others to use.

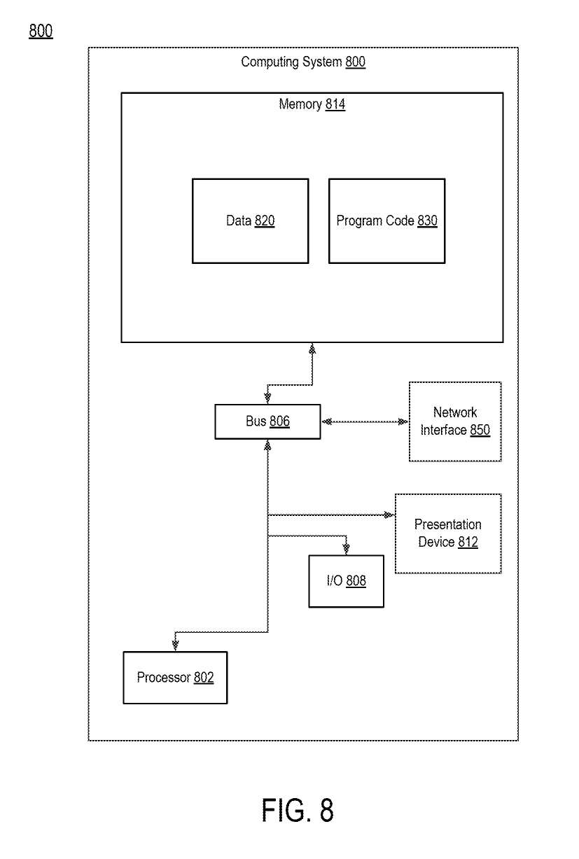

FIG. 8 depicts an example system for implementing a storage application according to certain embodiments of the present disclosure. Computing system 800 may implement the storage matching server 110, the user devices 101a-n. Computing system 800 may be implemented on a handheld device, smart phone, laptop or desktop computer. Some of the components of the computing system 800 can belong to the user devices 101a-n or storage matching server 110 of FIG. 1. For example, storage application 102a-n may operate on the computing system 800. The depicted example of a computing system 800 includes a processor 802 communicatively coupled to one or more memory devices 814. The processor 802 executes computer-executable program code 830 stored in a memory device 814, accesses data 820 stored in the memory device 814, or both. Examples of the processor 802 include a microprocessor, an application-specific integrated circuit (“ASIC”), a field-programmable gate array (“FPGA”), or any other suitable processing device. The processor 802 can include any number of processing devices or cores, including a single processing device. The functionality of the computing device may be implemented in hardware, software, firmware, or a combination thereof.

The memory device 814 includes any suitable computer-readable medium such as electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 800 may also include a number of external or internal devices such as input or output devices. For example, the computing system 800 is shown with an input/output (“I/O”) interface 808 that can receive input from input devices or provide output to output devices. A bus 806 can also be included in the computing system 800. The bus 806 can communicatively couple one or more components of the computing system 800 and allow for communication between such components.

The computing system 800 executes program code that configures the processor 802 to perform one or more of the operations described above with respect to FIGS. 1-8. The program code of the storage application 103, which can be in the form of non-transitory computer-executable instructions, can be resident in the memory device 814 or any suitable computer-readable medium and can be executed by the processor 802 or any other one or more suitable processor. Execution of such program code configures or causes the processor(s) to perform the operations described herein with respect to the user devices 101a-n or storage matching server 110. In additional or alternative embodiments, the program code described above can be stored in one or more memory devices accessible by the computing system 800 from a remote storage device via a data network. The computing device 104 and any processes can use the memory device 814. The memory device 814 can store, for example, additional programs, or data such as storage database 111, tenant database 112, barcode database 118, and landlord database 115, used by the applications executing on the processor 802 such as the storage applications 102a-n.

The computing system 800 also includes at least one network interface 850. The network interface 850 includes any device or group of devices suitable for establishing a wired or wireless data connection to one or more data networks. Non-limiting examples of the network interface 850 include an Ethernet network adapter, a modem, or the like. The computing system 800 is able to communicate with one or more other computing devices or computer-readable data sources via a data network using the network interface 850.

The computing system 800 includes a presentation device 812. A presentation device 812 can include any device or group of devices suitable for providing visual, auditory, or other suitable sensory output. Non-limiting examples of the presentation device 812 include a monitor, a speaker, a separate mobile computing device, etc.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes poses of example rather than limitation, and does not preclude the inclusion of such modifications, variations, or additions to the present subject matter as would be readily apparent to one of ordinary skill in the art.

What is claimed is:

1. A computer implemented method, comprising:
receiving, by a computing device from a first user device, a storage listing comprising storage parameters, the storage parameters including dimensions of available storage space within a storage location;
receiving, by the computing device from a second user device, a storage request comprising storage request parameters including dimensions of a plurality of storage objects;
determining, by the computing device, a storage space configuration for the available storage space, the storage space configuration comprising locations for the storage objects in an arrangement that maximizes use of the available storage space while leaving free space between the storage objects to allow access to each storage object;
determining, by the computing device, whether all of the storage objects fit within the storage space configuration; and
responsive to determining that storage objects fit within the storage space configuration, presenting the storage listing to the second user device.

2. The method of claim 1, further comprising:
responsive to receiving, by the computing device from the second user device, an indication that the storage space configuration is selected, marking the available storage to be occupied by the storage objects as allocated; and
responsive to marking the available storage to be occupied by the storage objects as allocated, determining, by the computing device, whether any remaining storage space exists in the storage location.

3. The method of claim 1, wherein the storage parameters further comprise dimensions of a smallest ingress point for accessing the storage location, the method further comprising:
determining, by the computing device, that the storage object can fit through the smallest ingress point; and
responsive to determining that all of the storage object cannot fit through the smallest ingress point, not presenting the storage listing to the second user device as an available storage option.

4. The method of claim 3, wherein the storage space configuration comprises locations for the storage objects in an arrangement that maximizes use of the available storage space while leaving free space between the storage objects to allow access to each storage object and free space between the storage objects to allow ingress into the storage location.

5. The method of claim 1, wherein determining the storage space configuration comprises providing a training set comprising training pairs to a machine learning model, wherein each training pair comprises (i) an image depicting a storage space and (ii) a known space configuration; and, for each training pair:
receiving, from the machine learning model, a predicted storage configuration,
calculating a loss function based on a difference between the predicted storage configuration and the known space configuration, and
adjusting a parameter of the machine learning model such that the loss function is minimized.

6. The method of claim 1, wherein the storage parameters further comprise a geographic location of the storage location, and wherein the storage request parameters further comprise a geographic storage area, the method further comprising determining that the geographic location of the storage location is within the geographic storage area.

7. The method of claim 1, wherein the storage parameters further comprise a duration for which the available storage space will remain available and wherein the storage request parameters further comprise a desired duration for use of the available storage space, the method further comprising determining that duration matches the desired duration.

8. The method of claim 1, further comprising:
responsive to determining that remaining storage space exists in the storage location, receiving, by the computing device from the first user device, a second storage listing comprising new storage parameters, the new storage parameters including dimensions of the remaining storage space;
receiving, by the computing device from a third user device, a new storage request comprising new storage request parameters including dimensions of a plurality of new storage objects;
determining, by the computing device, a new storage space configuration for the remaining storage space, the new storage space configuration comprising locations for the new storage objects in an arrangement that maximizes use of the remaining available storage space while leaving free space between the new storage objects and the storage object already stored in the storage location to allow access to each new storage object and each storage object already stored in the storage location;
determining, by the computing device, whether all of the new storage objects fit within the new storage space configuration; and
responsive to determining that all of the new storage objects fit within the new storage space configuration, presenting a new storage listing to the third user device.

9. The method of claim 1, wherein the storage space configuration indicates whether and how many of the storage objects can be stacked to maximize use of an available storage area in a vertical dimension.

10. A computer implemented method, comprising:
receiving, by a computing device from a first user device, a storage listing comprising storage parameters, the storage parameters including dimensions of available storage space within a storage location comprises the steps of:
receiving, by the computing device from a second user device, a storage request comprising storage request parameters including dimensions of a plurality of storage objects;
sorting, by the computing device the plurality of storage objects from largest to smallest; and
determining, by the computing device, a storage space configuration for the available storage space, by:
starting from a corner of the available space and working outward from said corner, determining first open spot to accommodate a largest storage object;
if the first open spot is in the corner, placing the largest storage object in the corner abutting a corner wall;
if the first open spot is not in the corner but otherwise abuts a wall, placing the largest storage object in the first open spot abutting the wall and leaving free space on the remaining three sides of the largest storage object for any adjacent storage objects;
if the first open spot does not abut any wall, placing the largest storage object in the first open spot and leaving free space on each of four sides of the largest storage object for any adjacent storage objects;
determining whether any vertical space is available for stacking another storage object on the largest storage object and, if so, placing the next largest storage object on top of the largest storage object;
determining whether any additional storage objects remain and, if so, determining whether there is any remaining available storage space that can accommodate at least one additional storage object; and
responsive to determining that there is remaining available storage space, iteratively re-determining the storage space configuration until all storage objects have been placed or there is no remaining available storage space.

11. The method of claim 10, further comprising:
responsive to receiving, by the computing device from the second user device, an indication that the storage space configuration is selected, marking the available storage to be occupied by the storage objects as allocated; and
responsive to marking the available storage to be occupied by the storage objects as allocated, determining, by the computing device, whether any remaining storage space exists in the storage location.

12. The method of claim 10, wherein the storage parameters further comprise dimensions of a smallest ingress point for accessing the storage location, wherein the method further comprises determining, by the computing device, that all of the storage object can fit through the smallest ingress point; and the method further comprising: responsive to determining that all of the storage object cannot fit through the smallest ingress point, not presenting the storage listing to the second user device as an available storage option.

13. The method of claim 12, wherein the storage space configuration comprises locations for the storage objects in an arrangement that maximizes use of the available storage space while leaving free space between the storage objects to allow access to each storage object and free space between the objects to allow ingress into the storage location.

14. The method of claim 12, wherein determining the storage space configuration comprises:
providing a training set comprising training pairs to a machine learning model, wherein each training pair comprises (i) an image depicting an object and a wall and (ii) a known space configuration; and, for each training pair:
receiving, from the machine learning model, a predicted storage configuration,
calculating a loss function based on a difference between the predicted storage configuration and the known space configuration, and
adjusting a parameter of the machine learning model such that the loss function is minimized.

15. A computer-readable storage medium storing non-transitory computer-executable program instructions, wherein when executed by a processing device, the non-transitory computer-executable program instructions cause the processing device to perform operations comprising:
receiving, by a computing device from a first user device, a storage listing comprising storage parameters, the storage parameters including dimensions of available storage space within a storage location;
receiving, by the computing device from a second user device, a storage request comprising storage request parameters including dimensions of a plurality of storage objects;
determining, by the computing device, a storage space configuration for the available storage space, the storage space configuration comprising locations for the storage objects in an arrangement that maximizes use of the available storage space while leaving free space between the storage objects to allow access to each storage object;
determining, by the computing device, whether all of the storage objects fit within the storage space configuration; and
responsive to determining that storage objects fit within the storage space configuration, presenting the storage listing to the second user device.

16. The computer-readable storage medium of claim 15, wherein the operations further comprise:
responsive to receiving, by the computing device from the second user device, an indication that the available storage configuration is selected, marking the available storage to be occupied by the storage objects as allocated; and
responsive to marking the available storage to be occupied by the storage objects as allocated, determining, by the computing device, whether any remaining storage space exists in the storage location.

17. The computer-readable storage medium of claim 15, wherein the storage parameters further comprise dimensions of a smallest ingress point for accessing the storage location, wherein the operations further comprise determining that all of the storage object can fit through the smallest ingress point; wherein the operations further comprise responsive to determining that all of the storage object cannot fit through the smallest ingress point, not presenting the storage listing to the second user device as an available storage option.

18. The computer-readable storage medium of claim 17, wherein the storage space configuration comprises locations for the storage objects in an arrangement that maximizes use of the available storage space while leaving free space between the storage objects to allow access to each storage object and free space between the objects to allow ingress into the storage location.

19. The method of claim 1, determining the storage space configuration comprises:
providing a training set comprising training pairs to a machine learning model, wherein each training pair comprises (i) an image depicting an object and a wall and (ii) a known space configuration; and, for each training pair:
receiving, from the machine learning model, a predicted storage configuration,
calculating a loss function based on a difference between the predicted storage configuration and the known space configuration, and
adjusting a parameter of the machine learning model such that the loss function is minimized.

20. The method of claim 1, wherein the storage parameters further comprise a geographic location of the storage location, and wherein the storage request parameters further comprise a geographic storage area and wherein the method further comprises, determining that the geographic location of the storage location is within the geographic storage area.
